(19) United States
(12) Patent Application Publication
(10) Pub. No.: US 2005/0033602 A1
(43) Pub. Date: Feb. 10, 2005

(54) Business-to-employee web services

(76) Inventors: Mark Cirinna, Spring, TX (US); John Mason, Spring, TX (US); Steve Jones, The Woodlands, TX (US); Diana Massaro, Houston, TX (US); Renay Rosckes, Cypress, TX (US)

Correspondence Address: HEWLETT-PACKARD COMPANY;Intellectual Property Administration, P.O. Box 272400, Fort Collins, CO, 80527-2400, US

(21) Appl. No.: 10/940,041

(22) Filed: Sep. 13, 2004

Related U.S. Application Data
(63) Continuation of application No. 09/578,667, filed on May 25, 2000.

(51) Int. Cl. G06F 17/60

(52) U.S. Cl. 705/1; 705/8

(57) ABSTRACT

A method and system for using a website to provide information, goods and services to an employee is provided. The method identifies information, goods or services that may assist employees perform their employment functions and the providers of the information, goods, and services. The method includes developing a website that enables an employee to obtain information, goods, or services to assist them perform their employment tasks. The system features a website that enables an employee to obtain information, products, or services to assist them perform employment functions.

### BACKGROUND OF THE INVENTION

1. Field of the Invention

The present invention relates generally to a system and method of providing web services. More particularly, the present invention relates to a system that can be configured to allow a business to use the Internet to provide employees with information, goods, and services.

2. Background of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The Internet has become an increasingly popular means for businesses and consumers to transmit information and to buy and sell goods and services. The Internet provides a business with the opportunity to reach a large consumer market. Consequently, businesses have created Internet websites to engage in commerce with consumers. These types of websites are known as business-to-consumer websites.

The Internet also provides a business with the opportunity to reach a larger business market. For example, the Internet makes it easy for manufacturers to conduct business with their suppliers. Consequently, businesses have created Internet websites to engage in commerce with other businesses. These types of websites are known as business-to-business websites.

A particular segment of the market for information, goods, and services that has gone untapped on the Internet is employees, or workers in similar occupations. These employees may be a business's own employees or the employees of other businesses. Employees have particular needs and requirements for information, goods, and services that cannot be met by business-to-business or business-to-consumer websites. For example, the process that a typical consumer would use to purchase goods is entirely different from the process that an employee would use to purchase goods. In this example, a consumer seeking an item may search the Internet for websites that offered the desired item for sale. The consumer may then purchase the item from one of the websites and wait for the item to arrive. The evaluation of the item and of the supplier rests entirely with the consumer. The diligence of the search for the correct item at the best value also rests entirely with the consumer. A consumer can choose to search through one website or a dozen.

This method of procurement may not be an acceptable method for an employee of a business. Having each employee spend time on the Internet searching for items is inefficient. Furthermore, for a variety of reasons employees are not typically allowed to purchase items at will at company expense. A managing authority within the business must usually authorize purchases. As a result, businesses typically establish formal procedures for the procurement of assets, such as items an employee needs or desires to perform job-related functions. These formal procedures may be quite time consuming, generate considerable amounts of documentation, and require several layers of employees and managers to function. These formal procedures may result in lower productivity and increased expense.

Additionally, the internal electronic information systems that businesses typically use to assist their employees are limited in their scope compared to the Internet. Workers outside the company cannot typically access these systems and obtain information, goods, or services.

The present invention may be directed to one or more of the problems set forth above.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one aspect of the present invention, there is provided a method of providing information, goods or services to employees. The method includes identifying the information, goods or services that may be used by employees to assist them perform their employment tasks. The method also includes identifying the providers of the information, goods or services that may assist the employees to perform their employment tasks. The method further includes developing a website so that employees may obtain the information, goods or services from the providers of the information, goods or services.

The method may include using the website to provide information, goods, or services to employees within a single business or to a plurality of businesses. The method may also include developing a configurable website system that would enable a plurality of websites to be developed. Each of these websites may enable a business to provide information, goods, or services to employees to assist them perform their jobs.

In accordance with another aspect of the present invention, there is provided a system for providing information, goods, or services to employees. The system includes a website operated by a business. The website provides information to an employee. The website also enables an employee to use the website to obtain products or services.

The system may be used by an employee of the business operating the website or by other employees. The system may also include a plurality of terminals for employee's to access the website. The system may also include a computer system and a computer program stored in the computer system. The computer program may provide a business with the ability to select from a template of information, goods, and services that the website may provide the business's employees.

In accordance with still another aspect of the present invention, there is provided a method for an employee of a business to procure goods, or services. The method includes accessing a website having a menu of goods or services available to the employee. The method also includes placing an order for a good or service by selecting the good or service from the menu. The method further includes sending an electronic representation of the order via the website to an authority for employee purchases within the employee's employer. The method also includes sending an electronic representation of the order to the source of the goods or services via the website upon approval by the approval authority. The method also includes providing the employee with the goods or services ordered.

### BRIEF DESCRIPTION OF THE DRAWINGS

The foregoing and other advantages of the invention will become apparent upon reading the following detailed description and upon reference to the drawings in which:

FIG. 1 illustrates a block diagram of a method of providing job function or industry specific information, goods, and services to employees, in accordance with the present invention;

FIG. 2 illustrates a block diagram of a system for employees that facilitates utilization of an Internet website to obtain general, job function or industry specific information, goods, and services, in accordance with the present invention;

FIG. 3 illustrates an example of general, job function or industry specific information, goods and services obtainable via an Internet website, in accordance with the present invention;

FIG. 4 illustrates a block diagram of a system for providing an employee with general, job function or industry specific information, goods and services, in accordance with the present invention;

FIG. 5 through FIG. 7 illustrate various aspects of the system of FIG. 4 in greater detail;

FIG. 8 illustrates an example of a web page for a website that provides an employee with general, job function or industry specific information, goods and services, in accordance with the present invention; and

FIG. 9 illustrates an example of additional menus of information, goods or services available to an employee at the website of FIG. 8.

### DESCRIPTION OF SPECIFIC EMBODIMENTS

One or more specific embodiments of the present invention will be described below. In an effort to provide a concise description of these embodiments, not all features of an actual implementation may be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

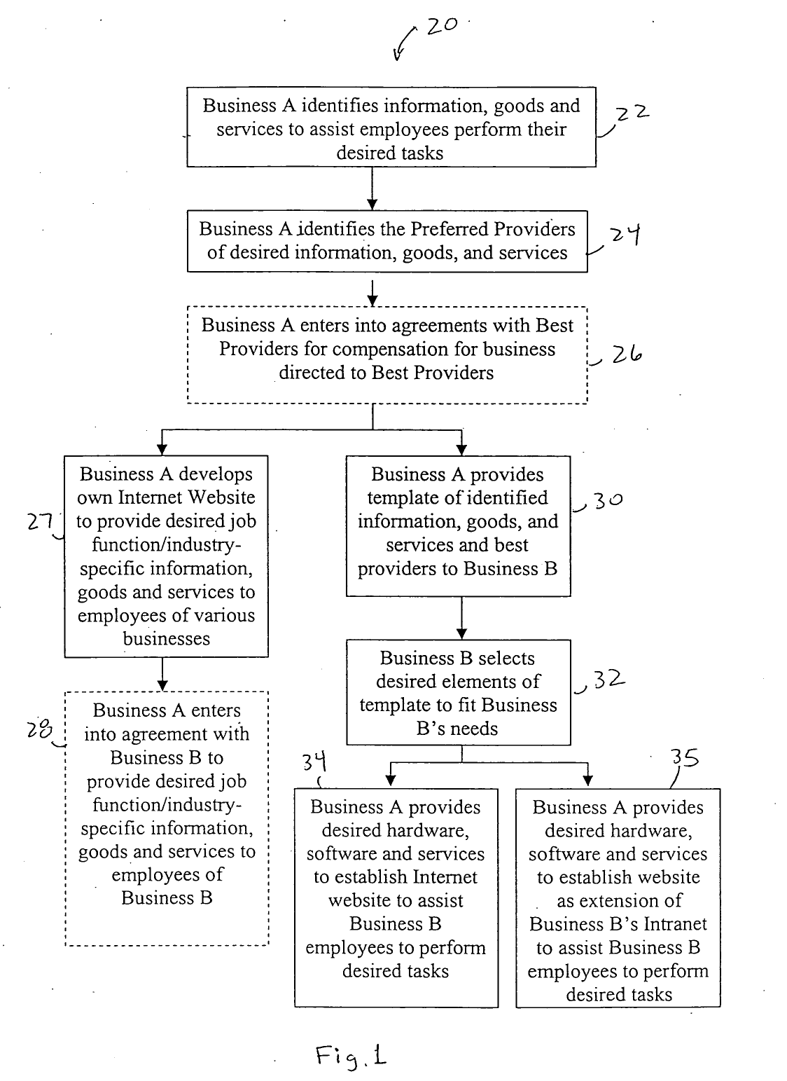

Turning now to the drawings, FIG. 1 illustrates a block diagram of a method, generally designated by the reference numeral 20, of providing job function or industry specific information, goods or services to employees. In the illustrated method, a first business, Business A, identifies the relevant information, goods and services that may assist employees in performing their jobs, as referenced by block 22. The information, goods, or services may be for employees performing specific jobs, for employees in specific industries, or for employees in general, for example. In block 24, Business A identifies the best sources, i.e., the Preferred Providers, of the different information, goods or services identified in block 22. The determination of which sources are the Preferred Providers may be based on a variety of factors, such as price and quality.

As an option, Business A may enter into business agreements with the Preferred Providers, as referenced by block 26. For example, Business A may contract with a Preferred Provider for a commission for each good purchased from the Preferred Provider by an employee that was directed to the Preferred Provider through the website. Additionally, Business A may negotiate volume discounts for goods or services purchased from the Preferred Providers.

Business A may develop its own stand-alone Internet website or Business A may provide a business with the tools to create its own Internet website or extend an installed information system. These websites may be used to provide employees with general information, goods and services or job function/industry specific information, goods and services.

Business A may develop its own website to provide information, goods and services to employees of its own business or of other employers, as referenced by block 27. The website may allow an employee to receive information that may assist the employee perform their job. This information may be tailored to employees with specific job functions or in specific industries. The website may also be linked to websites operated by a variety of information sources. Advertisement banners may also be placed on the website. Goods and services that may assist the employee perform their jobs may also be made available for purchase by the employee.

Business A may also enter in agreements with a second business, Business B, to provide information, goods, and services to Business B's employees, as referenced by block 28. The agreements may allow Business A to provide services to Business B's employees. Portions of the website may be configured for the exclusive use of Business B. Business B's employees may use the website for a variety of business functions, such as procurement, finance, sales, training, scheduling, etc. For example, an employee may access the website and request a desired good from a menu of goods developed by Business A, the goods being provided by the Preferred Providers. The website may then direct the request for the desired good to the appropriate approval authorities within Business B. Upon approval, the website may then be used by the approval authority to direct a purchase order to a website operated by a Preferred Provider. Upon delivery of the desired good, an employee may then access the website and notify an appropriate payment authority, such as Accounts-Receivable, of the delivery of the good. The payment authority may then use the website to transfer funds electronically to the Preferred Provider. The system may be configured with security precautions to ensure that only authorized personnel of Business B are allowed to access the portions of the website configured for Business B's use.

Additionally, or alternatively, Business A may enable businesses to develop their own Internet websites, as referenced by block 30. Business A may develop a template of information, goods, and services and Preferred Providers. Business A may then provide the template to a second business, Business B. The template allows employers, such as Business B, to chose the information, goods, services, and Preferred Providers that suit their own particular needs and desires, as referenced by block 32. Business A may then provide the hardware, software and services as necessary to enable Business B to establish an Internet website for the use of Business B's employees, as referenced by block 34. Business B's employees use the Internet website to obtain information, goods and services that enable, or assist, Business B's employees to perform their jobs. Furthermore, the website may be configured so that workers employed by other businesses may access portions of the website to obtain information, goods, and services.

Alternatively, Business A may enable businesses to develop and expand their current Intranet systems into websites, as referenced by block 35. Business A may provide Business B with the hardware, software and services as appropriate to develop a website that would provide Business B's employees with information, goods, and services. Such a website may combine features of Business B's Intranet with the template developed by Business A.

Some of the functional features that may be incorporated into an Internet website providing general, job function, or industry specific information, goods, and services to employees are featured. One function that an Internet website may provide is to enable employees to complete commercial transactions for the purchase of goods and services over the Internet. The types of transactions that may be completed via the Internet website include all manner of E-commerce, such as the ordering of computer hardware or software, literature, airline tickets, etc. The goods or services may be obtained from an internal source, from a Preferred Provider, or from some other external source. If the website were developed for a specific business's employees, the website may be configured so that the purchase order may be electronically and seamlessly routed to the appropriate authorizing, financing, and accounting authorities depending on the procedural framework of the business for purchasing.

The Internet website may be used to provide information to employees in a variety of ways. One way in which information may be provided to employees is through the content of the website. News may be produced by authors specifically for the website. News may also be provided via links to general news websites. Job function or industry specific information may be gleaned from websites across the Internet. Product or service news may be provided via links to websites operated by the Preferred Providers or other product or service providers. Additionally, the content of the website may be customized for each employee. News of particular relevance to an employee may be brought to the employee's attention.

Information may also be disseminated to employees via online interaction with other employees logged onto the website. This interaction may be in the form of chat rooms, a customized newsletter, or discussion groups. Employees may also be connected online to experts or consultants provided by the Preferred Providers, or other third party businesses. For example, a technician having problems repairing a computer may enter a chat room or discussion group for guidance and assistance from other technicians employed within the industry.

Information may also be obtained from the website in order to perform profiling. This information may be obtained by tracking the employees use of the website. Among other things, this information may be used to configure the website for each employee or to target advertising to specific employees based on their use of the website.

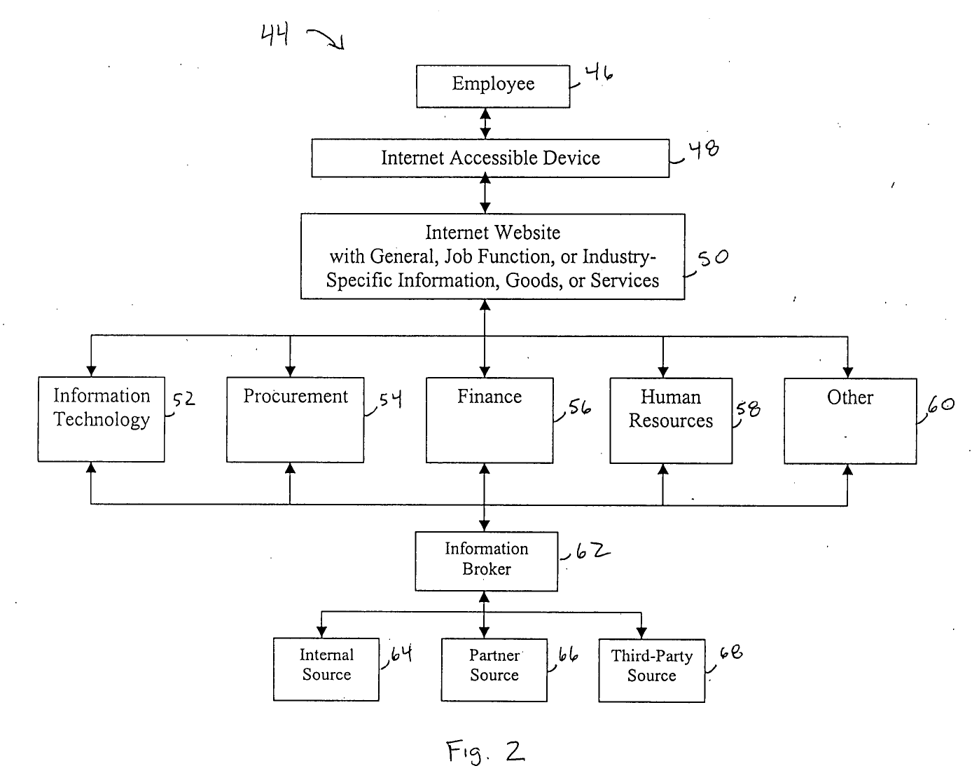

Referring generally to FIG. 2, a block diagram is shown of a system 44 that allows employees to utilize an Internet website to obtain job function or industry specific information, goods and services. In the illustrated system, an employee, as referenced by block 46, utilizes an Internet accessible device, as referenced by block 48, to access the Internet. The Internet accessible device may be any of a variety of different Internet accessible devices, such as a desktop computer, a laptop computer, a hand-held computer, or a telephone. The employee 46 uses the Internet accessible device 48 to access an Internet website, as referenced by block 50. The Internet website 50 enables the employee 46 to obtain job function or industry specific information goods and services.

In the illustrated embodiment; employees utilize different portions of the Internet website depending upon their specific job functions. For example, employees in information technologies may primarily use a portion of the website devoted specifically to information technology, as referenced in block 52. A portion of the Internet website may be devoted specifically to employees devoted to the procurement of goods and services, as referenced in block 54. Another portion of the Internet website may be devoted primarily to finance, as referenced block 56. Still another portion of the Internet website may be devoted to human resources issues, as reference in block 58. Other portions of the website may be devoted to employees in other job descriptions or to issues relevant to all employees, as referenced in block 60.

From these various job function related portions of the Internet website, information can be obtained through the use of an information broker, as referenced in block 62. In the illustrated method, the information broker 62 searches for the desired information, goods or services among a variety of sources. Some information, goods or services may be obtainable through internal sources of the company, as referenced in block 64. Other information, goods or services may be available from one of the best providers or partners, as referenced in block 66. Finally, additional information, goods or services may be obtained from unaffiliated third-party sources, as referenced in block 68. In the illustrated method, the Internet website has closed links to external sources, such as a preferred provider or third-party source. Thus, there is seamless communication between the Internet website and any Internet websites operated by preferred providers or third-party sources. The website may be used to provide information, goods and services to employees in a variety of formats. For example, the website may be arranged topically by subject matter of the information, good or service or by the job function of the employee.

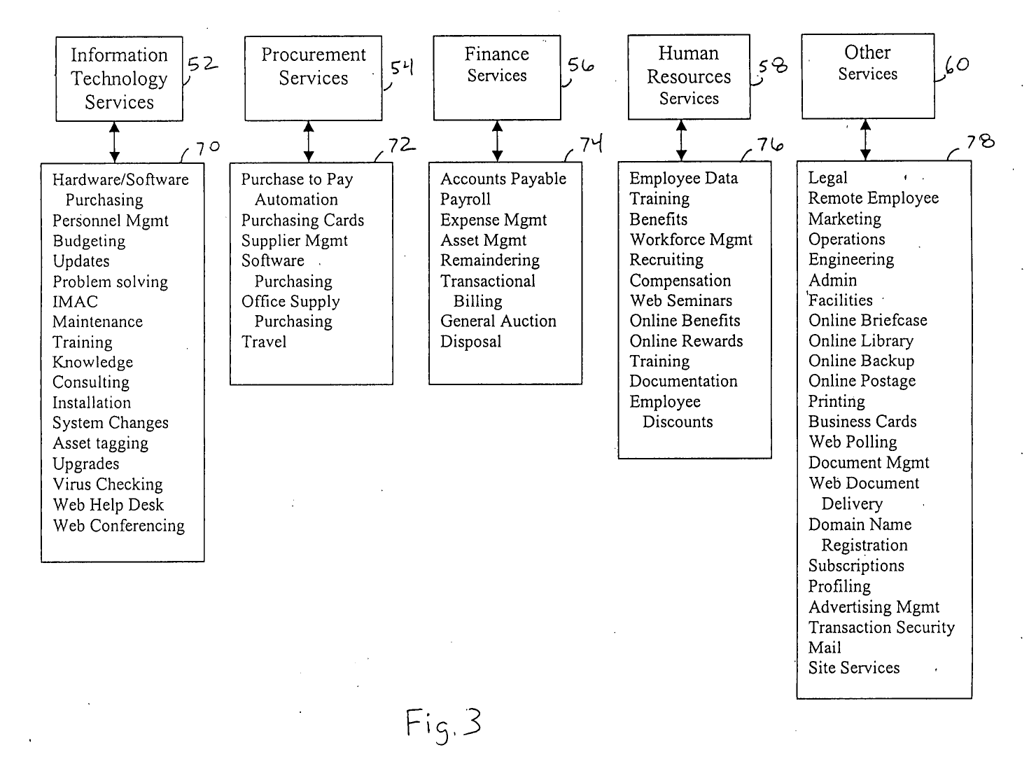

Referring to FIG. 3, a sample is provided of general, job function, or industry specific information, goods and services that may be obtained via the Internet website. For example, employees may access the website and use the Information Technology portion 52 of the website to obtain a variety of information, goods and services related to Information Technology or desired by employees in Information Technology fields, as provided in block 70. An Information Technology manager may use this portion of the website for various functions, such as personnel management, budgeting, maintaining technological proficiency, problem identification and resolution, and end user training and support. The website may be used to provide a manager with information on pricing, delivery updates, product comparisons, demand forecasting, and system integration guidelines.

The website can also be used for obtaining and providing services such as information management and control, or IMAC, maintenance and training, as well as documenting maintenance, training, assets, and system changes. The website may also be used for system upgrades and virus checking. Information Technology related information may also be provided by the website, such as news relevant to the field of Information Technology, Information Technology training, a web help desk, or providing web conferencing.

The Internet website may be used to provide for the automation of the procurement process from the point of ordering the goods or services by the employee to the point of payment of the supplier. For example, when an Information Technology worker orders a computer from the Information Technology portion of the website a purchase order may automatically be generated that is then routed to the Procurement portion 54 of the website. Procurement workers may then utilize the Procurement portion 54 of the website to process the request form. The Procurement portion of the website may be closed-linked to websites maintained by the Preferred Providers. A procurement employee may then use the Procurement portion of the website to direct the Preferred Provider to ship the computer. Additionally, the order may be directed to the Finance portion of the website so that a finance employee in Accounts Payable can docket payment for the computer. As a result, all of the functions of purchasing may be performed from the website and would be invisible to the Information Technology employee who initially ordered the computer. The Internet website may be used to provide a single Internet website that may seamlessly connect employees within one company to suppliers in another company.

Additionally, employees may also use the Procurement portion of the website to manage suppliers, plan trips through travel agencies, and purchase office supplies. The Finance portion of the website may also be used for payroll, expense management, asset management, and remaindering.

The Internet website may also be used to provide a variety of Human Resource services, as provided in block 76. For example, the website may be used to develop employee data. The website may also be used to document and track employee training and assist in workforce management, such as scheduling vacations and recruiting. Additionally, the website may be used to provide a variety of information to employees, such as benefits.

A variety of other services may be provided by the website, as provided in block 78. Legal questions and concerns may be directed to legal authorities via the website. Standard form contracts approved by the business's legal authority may be stored and accessible from the website. Employee data, or profiling, may be developed by tracking employee use of the website, or the Internet. Additional services such as engineering, operations, administration, or facilities may all use and be accessible from the website. Please note that this is not an exclusive list of information, goods or services that may be provided to an employee from the website.

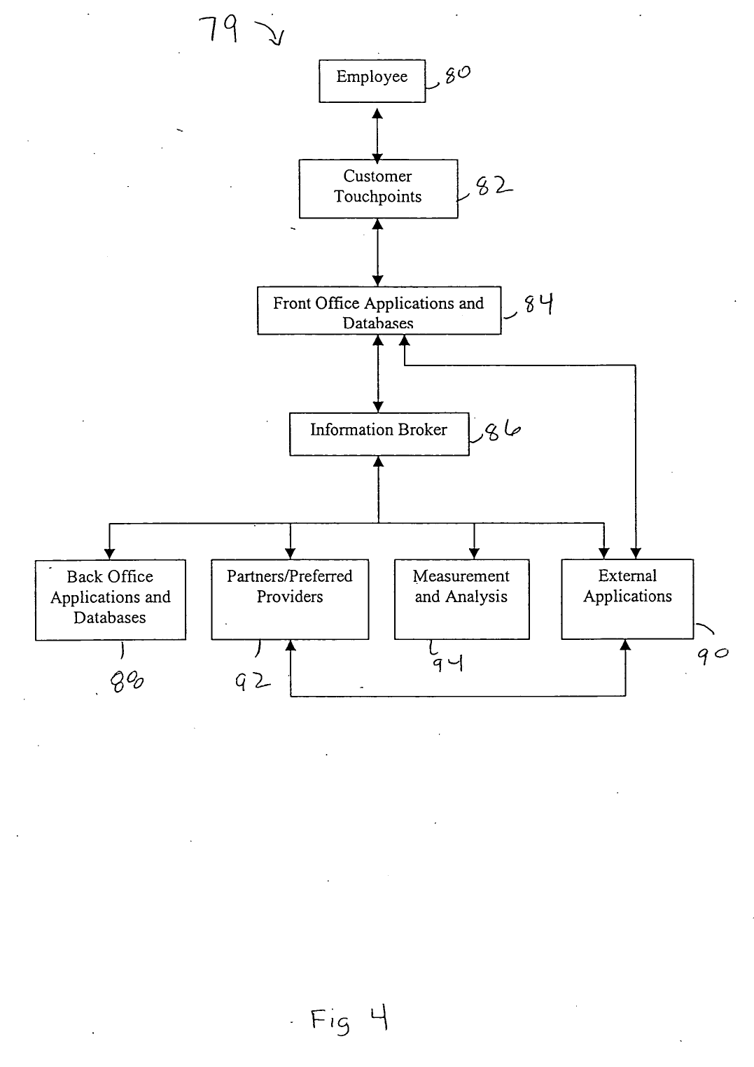

Referring generally to FIG. 4, a block diagram is shown of a website system 79 for providing a worker/employee with general, job function or industry specific information, goods, and services. The website system 79 utilizes a variety of computer hardware and software applications to perform its desired functions. The specific functions and applications incorporated into the website system may vary depending upon the needs of the business utilizing the website. A business may select from among these, or other, functions for the website 79. Additionally, partners may be brought in to provide some or all of the applications used by the system 79.

In the illustrated system, a worker/employee, as referenced by block 80, utilizes touchpoints, as referenced by block 82, to interact with a business. The touchpoints connect the worker/employee with Front Office applications and databases, as referenced by block 84. The Front Office applications and databases are applications that the employee can interact with in real time. The Information Broker, as referenced by block 86, moves information around the system and ensures that applications have up-to-date information. Some applications may communicate information directly between the applications without the use of the Information Broker 86. The Back Office applications, as referenced by block 88, are those applications that are used to run and report on the business. External applications, as referenced by block 90, are any third party source of information, goods or services. Block 92 represents the information provided by partners or Preferred Providers. The information may or may not be integrated into the business's Back Office applications. Measurement and Analysis, as referenced by block 94, is the central storage area for information and analysis.

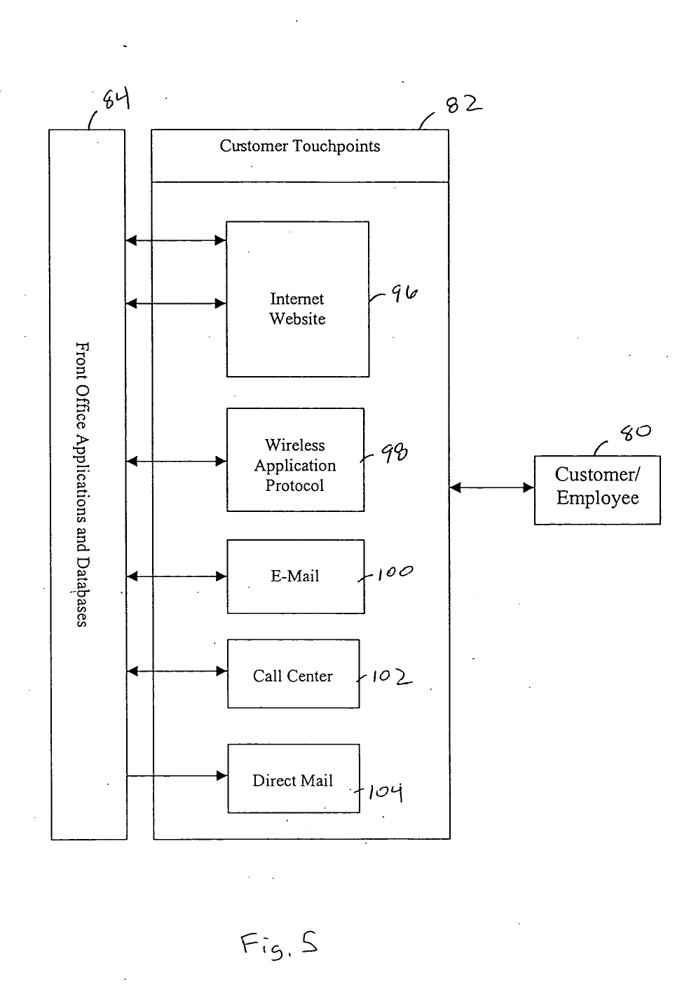

As best illustrated in FIG. 5, touchpoints may include the company's website 96 accessed by a computer, wireless devices 98, e-mail 100, a customer call center 102 or even direct mail 104. Wireless devices 98 that may access the website include digital mobile phones, pagers, personal digital assistants.

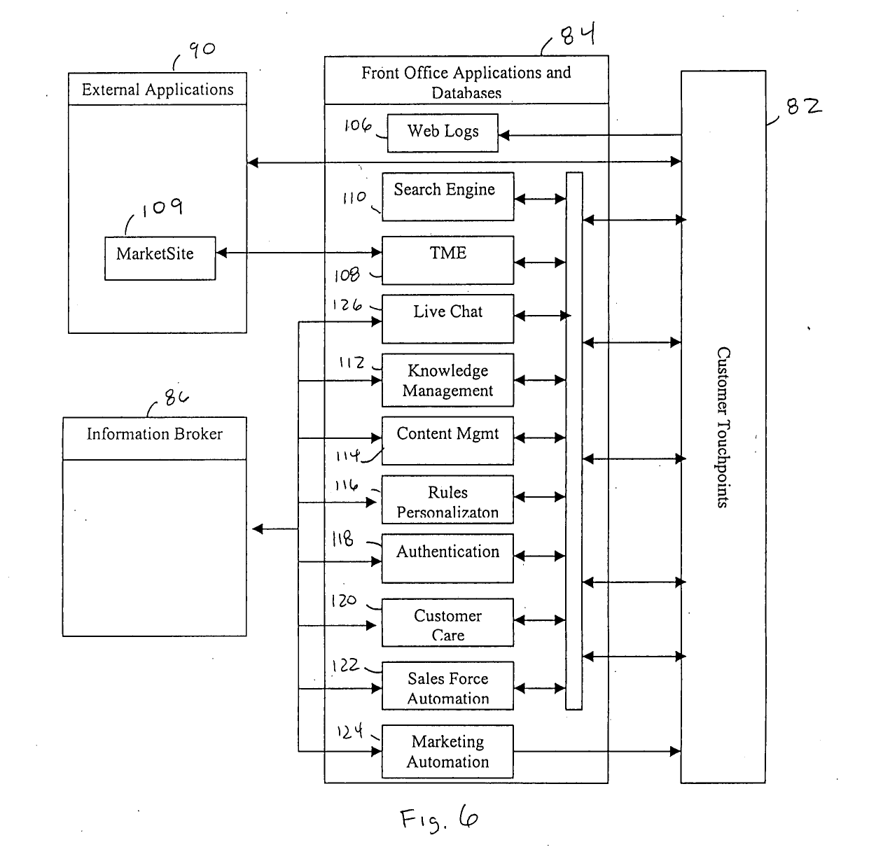

As best illustrated in FIG. 6, the Front Office applications and databases 84 may perform a myriad of functions in coordination with the Information Broker and the External applications. One Front Office Application that may be used is a web log 106. All web pages hosted by the site may be logged to files with basic information, such as the URL, date and cookies. Another application that may be used by a business is a Transaction Marketplace Engine (TME) 108. The TME 108 may be used to manage e-commerce transactions. Information may also be provided to the TME from other applications, such as an external Market Site 109.

A search engine 110 may be used to provide the customer/employee with the ability to search for information, goods, and services. Processes, procedures, contacts and information on how to run the business may be managed by a knowledge management application 112. A content management application 114 may be used to provide directory and workforce tools to help organize the content of information sent to the various touchpoint applications and to allow for collaborative development of applications. A rules personalization application 116 may be used to provide the rules for the presentation of web pages. An authentication application 118 may be used for security as well as to develop customer/employee profiles. A customer care application 120 may be used to manage customer/employee issues. A sales force automation application 122 may be used to provide sales force personnel with tools, such as contact management and scheduling. A marketing automation application 124 may be used to deliver personalized messages to customer/employees via the website, e-mail, etc. A chat/instant messaging application 126 may also be used to allow employees to communicate directly with each other, specific partners, or others similarly interested. Additionally, each Front Office Application may have its own specific data model and database optimized for its use.

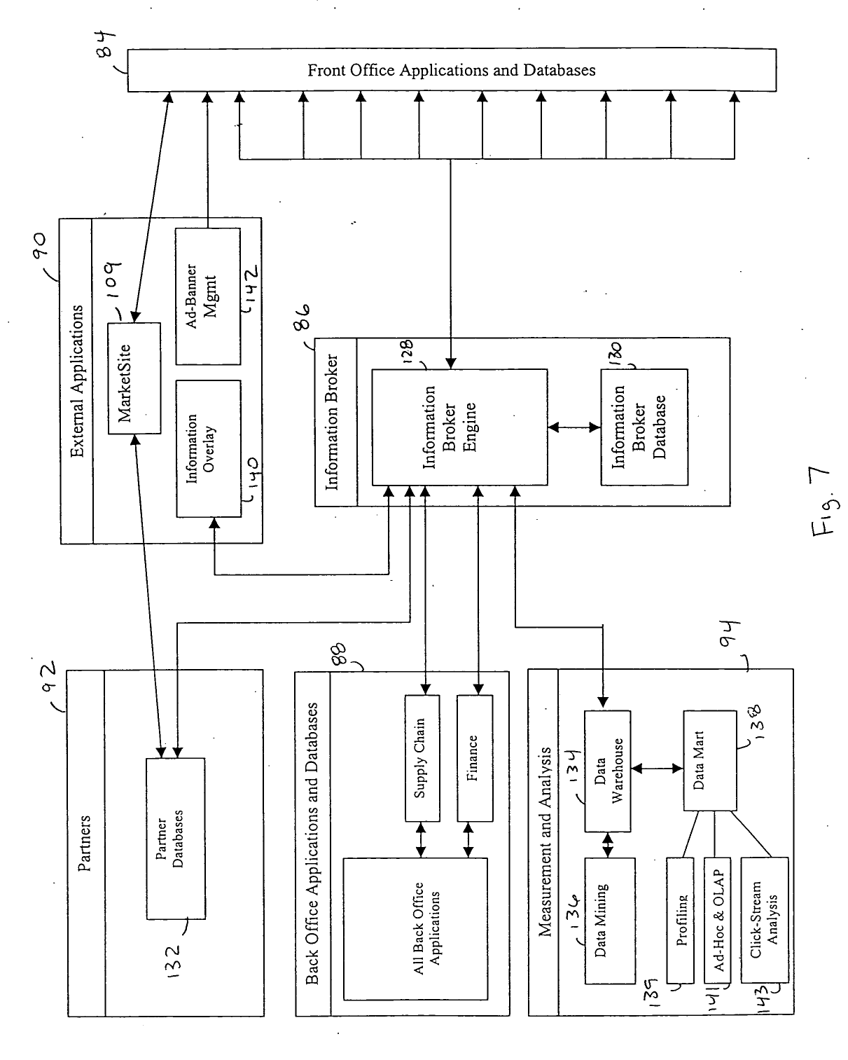

As best illustrated in FIG. 7, the Information Broker 86 includes an engine 128 and a database 130. The engine 128 operates on a set of rules to move information around the system to the various applications. The rules, metadata, logs and information required for recovery and batch movement are stored in the database 130. The engine code may be constructed from customized code, such as C++, utilize RDBMS tools, migration tools, or a number of other software tools.

The Back Office applications and databases are applications that are used by a business to manage the business. The Back Office applications and databases may include applications to manage financial services, such as accounts receivable and accounts payable. Applications to manage the supply chain, such as inventory, manufacturing and shipping, may also be included.

In the illustrated embodiment, information can also be obtained from databases maintained by partners or Preferred Providers 132. The Information Broker 86 is used to provide various applications and databases with the information obtained from the databases maintained by the partners or Preferred Providers 132. Partner/Preferred Provider databases 132 may be used to store a variety of pertinent information, such as the cost and availability of goods, and shipment tracking information. This information may be obtained in real time as changes occur or periodically and provided to the appropriate application within the system.

In the illustrated embodiment, the Information Broker 86 is used to enable Measurement and Analysis applications 94 to store and analyze information. This portion of the website may be used to personalize the website for each customer/employee. In the illustrated embodiment, the Measurement ands Analysis applications include a data warehouse 134. The data warehouse 134 stores customer/employee data for the business, e.g., customer/employee names, communications, transactions, and demographics. This information may be updated by the Information Broker 86 in real time or on a periodic basis. The illustrated embodiment also includes a data mining application 136. The data mining application 136 uses analysis techniques to isolate data sets and detect employee/customer trends, such as the employee/customer's next purchase. The illustrated embodiment also includes a data mart 138. The data mart 138 includes a variety of tools to assist in analysis and reporting. For example, the data mart 138 may include applications for customer/employee profiling 139, including forecasting and partner/Preferred Provider reporting. The data mart may also include Ad-Hoc and OLAP 141 for spreadsheet type analysis of reporting topics. The data mart may also include click-stream analysis 143 for profiling such as, measuring the effectiveness of the website based on the web logs or by overlaying web logs on employee/customer information.

In the illustrated embodiment, the Information Broker 86 is also used to coordinate the system with External applications 90. For example, the Information Broker 86 may be utilized with an information overlay application 140. The information overlay 140 is a source of additional information available to “overlay” on top of a customer employee's information for use in analysis and segmentation. This information may also be communicated to the Measurement and Analysis applications 94 for profiling. The External applications may also interact directly with the Front Office applications and databases 82. For example, an advertising banner management application 142 may be used to position advertisements for the website on other websites, thus bringing additional customer/employee's to the website. The information may also be communicated by the Information Broker 86 to the Measurements and Analysis applications 94 to determine the overall effectiveness of the advertising.

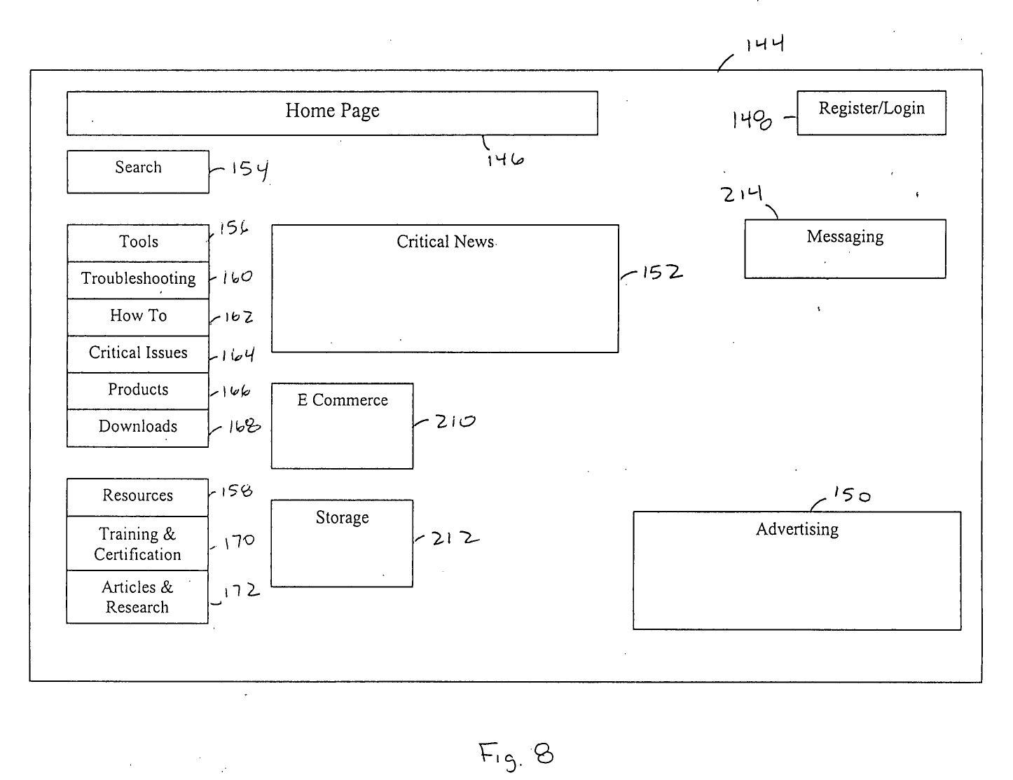

An example is provided in FIG. 8 of an embodiment of a web page 144 for a website that provides employees with information, goods, and services. The web page may be used for a website constructed by a business, as per block 27 of the method of FIG. 1. The web page may also be configurable so that it may serve as part of the hardware, software and services provided by one business to a number of other businesses, as per block 34 of the method of FIG. 1. The web page may also be used as part of an Intranet system, as per block 35 of the method of FIG. 1. The illustrated web page represents what an employee using a computer accessing the website would see. The computer displaying the website is serving as the employee's touchpoint 82 to the system. The web page 144 includes a banner 146 identifying the web page as the Home Page for the website.

The web page also includes a number of pull-down menus and buttons that can be operated to send a user to other web pages or to initiate applications, such as the Front Office applications 84. One of the buttons featured on the illustrated web page is a register/login button 148. The register/login button 148 activates the Authentication 118 application to identify the specific user of the website. This information can be used for a variety of purposes, such as to customize the web page for the user based on the employee profiling data or as a security measure to prevent unauthorized access to secure portions of the website. The content management application 114 may configure the web site so that an information technology employee would see a web page configured for information technology employees and a procurement employee would see a web page configured for procurement employees.

The illustrated web page also includes an advertising banner 150. The advertising banner 150 is operated by the Ad-Banner Management 142 application, which is also supplied with employee profiling data. In the illustrated embodiment, critical news 152 to the employee is also displayed. The critical news 152 can also be configured for each user based on the employee profiling data. The profiling data is supplied to these applications from the Measurement and Analysis 94 portion of the website via the Information Broker 86.

The illustrated web page also includes a search button 154. The search button activates the search engine 110 to search the website for specific information, goods or services. The web page also includes other tools 156 and resources 158 to assist employee's perform their jobs. The tools 156 include a troubleshooting menu 160, a How To menu 162, a critical issues menu 164, a products menu 166, and a download menu 168. The resources 158 include a training and certification menu 170 and an articles & research menu 172.

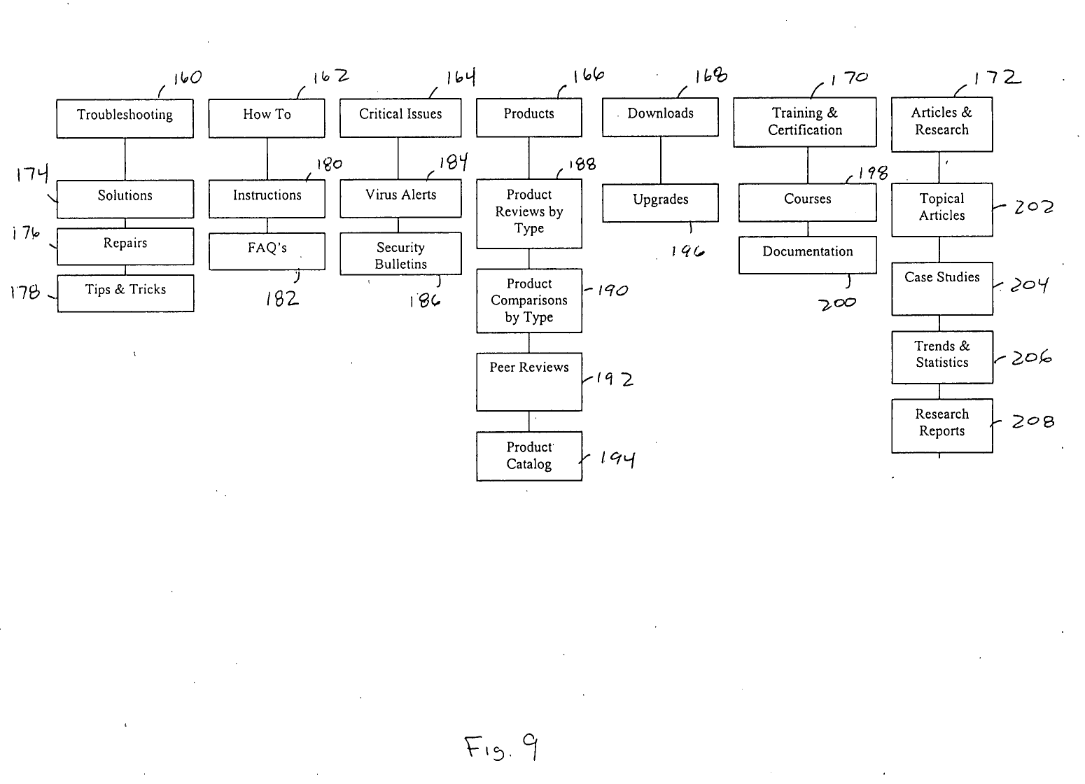

As best illustrated in FIG. 9, these menus direct the employee to sources of information, goods and services. For example, the troubleshooting menu 160 may include a solutions application 174 that may assist the employee in identifying and correcting problems, information on repairs 176, or tips & tricks 178 provided by a Preferred Provider. The How To menu 162 may provide the employee with additional information such as instructions 180 on how to perform certain tasks or frequently asked questions, FAQ's 182. The critical issues menu 164 may provide the employee with virus-alerts 184 or security bulletins 186. The products menu 166 may be used to obtain a variety of information about goods, such as product reviews by type of good 188, product comparisons 190, peer reviews 192, and a product catalog 194. The downloads menu 168 may be used to provide employees with upgrades 196 to download from the website. The training and certification menu 168 may be used to identify training courses 198, to sign up for training courses or to document courses taken 200. The articles and research menu 172 may be used to provide an employee with topical articles 202, research or perform case studies 204, analyze trends or perform statistical analysis 206, or read or write research reports 208. In the illustrated embodiment, the information provided from external sources are connected to the website via a closed-link so that the employee experiences a seamless web environment. Furthermore, this is not an exclusive list of information, goods or services available from the web site.

After using the tools and resources described above, an employee desiring goods or services may activate the E Commerce button 210. The E Commerce button 210 activates the Transaction Marketplace Engine, or TME, 108. The TME may send the employee to another page in the website or open a window to conduct the transaction. The TME would route the request for the goods or services to another portion of the web site where a procurement employee would receive the request on a web page configured for procurement. The procurement authority would use the procurement web page to process the request and order the goods. Alternatively, the TME may route a request directly to a partner, or preferred provider, through the website, or email, via directed approval workflow.

The illustrated web page also includes a number of other functions to assist employees. The web site allows employees to store information on the web site. A storage button 212 directs the employee to the applications or files in which the information is stored. Finally, a messaging button 214 directs the employee to communications applications, such as e-mail or instant messaging.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1-43. (Cancelled).

44. A system for providing information, goods, or services, comprising:
an electronic information system adapted to produce a publicly accessible website operable to provide job-function related information topics to any person that accesses the website,
wherein the electronic information system enables an authorized employee of a business to use the website to order a product from a selection of products authorized by the business for automatic purchase by the authorized employee with payment for the product being provided by the business, and
wherein the electronic information system also enables a non-employee of the business to use the website to order a product with payment for the product being provided by the non-employee of the business when the product is ordered.

45. The system as recited in claim 44, wherein the website provides the non-employee of the business with a second selection of products for purchase.

46. The system as recited in claim 44, wherein the electronic information system is programmed to route an order for a product through the system for payment processing by the business when the authorized employee orders the product.

47. The system as recited in claim 44, comprising: a plurality of terminals that enable a plurality of authorized employees to access the publicly-accessible website

48. The system as recited in claim 44, wherein the system comprises:
a computer network; and
a computer program stored in the computer network.

49. The system as recited in claim 48, wherein the computer program provides the business with the ability to select from a template of goods and services that the website may provide to an authorized employee.

50. The system as recited in claim 47, wherein the publicly-accessible website is accessible via the Internet.

51. The system as recited in claim 44, wherein the system is configured to identify each employee of the business accessing the website.

52. The system as recited in claim 51, wherein the system tracks usage of the website by each employee of the business.

53. The system as recited in claim 52, wherein the system selects a specific job-function related topic for display on the website for each employee based on previous usage of the website by the employee.

54. The system as recited in claim 47, wherein the system is linked to a second electronic information system via a second website.

55. The system as recited in claim 54, wherein the computer program comprises a plurality of websites linked together.

56. The system as recited in claim 55, wherein the links to the plurality of websites are closed links, such that when a link in a first website is activated it visually appears to the authorized employee that the authorized employee is still connected to the first website and it does not appear to the authorized employee that the authorized employee is linked to a second website.

57. The system as recited in claim 44, wherein the system is configured to provide information, products, and services to authorized employees of the business in specific occupational groups.

58. A system, comprising:
a computer system; and
a website hosted by the computer system, wherein the website enables an authorized employee of an employer to obtain purchasing-related job function information and non-purchasing-related job-function information, and the website enables the authorized employee to order a product to assist the employee to perform employment functions from a menu authorized by the employer based on job-function of the employee,
wherein the computer system automatically routes a purchase order to the employer for approval and payment after the authorized employee orders the product.

59. The system as recited in claim 58, wherein the website is accessible over the Internet.

60. The system as recited in claim 58, wherein a portion of the website is configured topically by employee job function.

61. The system as recited in claim 58, wherein the website is adaptable for each employee that accesses the website.

62. The system as recited in claim 58, wherein the website is provided to employees by a first business.

63. The system as recited in claim 62, wherein the website has a link to a second website operated by a second business.

64. The system as recited in 63, wherein the link to the second website is a closed-link such that when a link in the website is activated it visually appears to the authorized employee that the authorized employee is still connected to the website and it does not appear visually to the authorized employee that the employee is linked to a second website.

65. The system as recited in claim 63, wherein the first business receives compensation electronically from the second business for transactions completed by the authorized employee with the second website.

66. The system as recited in claim 63, wherein the system documents all transactions completed by the authorized employee.

67. The system as recited in claim 62, wherein the website enables an employee of any business to obtain purchasing-related job function information and non-purchasing-related job-function information, and wherein the website enables the employee of any business to order a product to assist the employee of any business to perform employment functions from a menu with payment for the product being provided by the employee of any business when the product is ordered.

68. The system as recited in claim 58, where the system is configurable so that a business may select the information, goods, or services to be displayed on the website.

69. The system as recited in claim 58, wherein the product comprises a computer software application stored on the computer.

70. The system as recited in claim 58, wherein the product comprises a computer software application accessed from a second website.

71. A system for enabling employees of an employer to order goods or services, comprising:
a website operable to provide employees of the employer with a selection of products authorized by the employer for ordering and to enable the employees to order a product from the selection of products; and
an electronic information system operable to host the website, wherein the electronic information system provides a first group of employees with a first selection of products authorized by the employer and provides a second group of employees that is different from the first group of employees with a second selection of products that is different than the first selection of products.

72. The system as recited in claim 71, wherein the website is operable to provide the employees with employment-related information.

73. The system as recited in claim 72, wherein the electronic information system provides a first set of employees with a first selection of employment-related information and provides a second set of employees, different from the first set of employees, with a second selection of employment-related information, different from the first selection of employment-related information.

74. The system as recited in claim 71, wherein the electronic information system automatically provides for payment of the product without input from the employee.

75. The system as recited in claim 74, wherein the electronic information system automatically provides for approval of the order of the product without input from the employee.
